(19) United States
(12) Patent Application Publication
(10) Pub. No.: US 2012/0191475 A1
(43) Pub. Date: Jul. 26, 2012

(54) Method and system for user centric, centralized access and management of healthcare related information, day today functions and administrative functions across multiple providers and entities in the healthcare eco-system

(75) Inventor: Abhishek Pandey, Malvern, PA (US)

(73) Assignee: Abhishek Pandey, Malvern, PA (US)

(21) Appl. No.: 13/345,651

(22) Filed: Jan. 6, 2012

Related U.S. Application Data
(60) Provisional application No. 61/430,717, filed on Jan. 7, 2011.

(51) Int. Cl. G06Q 50/22; G06Q 50/24

(52) U.S. Cl. 705/3; 705/2

(57) ABSTRACT

Software system that provides a user (such as an insurance holder) centric, user managed centralized system to enable user to manage his health and wellness community which includes multiple participants such as insurance providers, dependents covered under insurance, healthcare providers (such as physician practices and pharmacies), wellness partners, health and wellness devices and other entities such as Center for. Disease Control (CDC). The system allows a user to manage and analyze health and wellness related information, to perform analytics on health and wellness related information, to perform health and wellness related day today functions (such as schedule an appointment, request health record for child care facility), to access health and wellness related information from the participants in his health and wellness community and to maintain and manage an active relationship with healthcare providers, wellness participants and other entities in his health and wellness community electronically and securely from one place.

### RELATED U.S. PATENT DOCUMENTS

Non Provisional application Ser. No. 13/345,651 filed on Jan 6, 2012

### FIELD OF INVENTION

Relates to Software systems and methods that provide a user (such as an insurance holder) centric, user managed centralized system to enable user to manage his health and wellness community which includes multiple participants such as insurance providers, dependents covered under insurance, healthcare providers (such as physician practices and pharmacies), wellness partners, health and wellness devices and other entities such as Center for Disease Control (CDC). The system allows a user to manage and analyze health and wellness related information, to perform analytics on health and wellness related information, to perform health and wellness related day today functions (such as schedule an appointment, request health record for child care facility), to access health and wellness related information from the participants in his health and wellness community and to maintain and manage an active relationship with healthcare providers, wellness participants and other entities in his health and wellness community electronically and securely from one place.

### BACKGROUND OF INVENTION

Patient Engagement is recognized as a growing need today to encourage the population to be an active participant in managing their health. Today, more and more focus is on prevention and wellness. Focus is not just on doctor-patient interaction, also on patient and health and wellness community interaction. Increasing number of people are choosing to manage their health and wellness routinely.

With the increasing emphasis on patient engagement there is a need for a user (such as an insurance holder) centric, centralized place for collaboration with health and wellness community, easy access and management of health and wellness related information and ability to perform health and wellness related day today functions electronically. There is also a need for user managed active relationship with participants in user's health and wellness community.

As can be appreciated by one skilled in art that present system may be implemented in several different forms. Example implementations relate to providing a centralized system to allow users to manage health and wellness related information and perform health and wellness related actions over the internet via several devices such as smart phone, personal digital assistants, laptops and computers.

The present system relates to Software systems and methods that provide a user (such as an insurance holder) centric, user managed centralized mechanism to enable the user to manage his health and wellness community which includes insurance providers, dependents covered under insurance, healthcare providers (such as physician practices and pharmacies), wellness partners. The system allows a user to perform day today health and wellness related activities electronically from one place. Some of these activities include Scheduling appointments, requesting co-pay statements for FSA claims, requesting Health records for children, dispatching children health records to school and child care facilities, requesting prescription refills, making payments for healthcare bills and non-emergency questions for the nurse. System integrates with Personal Health Record (PHRs) and other participants using mechanisms such as ‘Direct Project’ to provide user a view of clinical information related to user.

### Healthcare Ecosystem

Individuals in any population consume services of healthcare providers, wellness partners and other entities such as Center for Disease Control (CDC). These individuals are often part of a health and wellness community which includes insurance providers, wellness partners, healthcare providers and other entities such as CDC. Such individuals are herein referred to as “user”.

An insurance holder can have one or more dependents covered under his insurance. Insurance holder and his dependents have a health and wellness community wherein insurance holder and dependents have multiple health and wellness providers and partners and participants in their community. Providers include healthcare providers such as family physicians, pediatricians, gynecologists, dentists or other specialized healthcare providers such as ophthalmologists, physical therapist. Participants include pharmacies, urgent care clinics and other authorized entities. Other possible partners in a user's health and wellness community include wellness programs, fitness centers or medical homes.

A user interacts with a variety of entities herein referred to as “participants” which include healthcare providers, wellness participants, insurance providers, child care facilities, school facilities, urgent care clinics, pharmacies, dependents covered under user's insurance in his health and wellness community, herein referred to as user's “Health Ecosystem” (HEco).

Typically an insurance holder and his dependents have regular scheduled visits to participants in their health and wellness community. They often schedule appointments for periodic checkups, wellness visits with one or more of these participants and receive reminders from these participants via mail or telephone.

The Present system enables a user to manage information and participants in his health and wellness community, to define health and wellness profile for self and dependents, perform variety of day today functions related to health and wellness across a variety of participants. Following are some examples of day today functions:
Scheduling appointments
Prescription fills/refills
Request for Health Records from provider
Send Health Records to school facilities and other child care facilities.
Request for co-pay statements for Health care reimbursements
Request for Lab results
Non-emergency questions for Nurse
Real time conversation with physician or nurses
Eligibility checks for coverage
Send updated profile information to health and wellness participants

Today a user performs these functions over phone or in person. The present system enables the user to perform these day today functions electronically across a variety of participants from one place.

A user often also has the need to view health and wellness related information across variety of participants. Example information include:
Visit Summary from a visit
Last year's annual health check up data such as cholesterol.
Growth chart for child from last visit

System integrates with PHRs and other participants using mechanisms such as ‘Direct Project’ to provide the user a secure view of clinical information.

Today, a user provides information to the participants in his HEco which includes:
Demographics information
Insurance information
Family health history
Basic health and wellness information (such as “how many times do you exercise”, “are you pregnant” etc.)
Contact information, Payment information

The said information is maintained by each participant. If there is an update to the said information, user needs to communicate the update to each participant. For example, if a user changes insurance, he has to communicate the change in insurance to his healthcare providers individually. The Present system allows a user to store the said information herein referred to as ‘HEco user profile’ (Health Ecosystem user profile) at one place. System allows a user to send one or more attributes from the HEco user profile to HEco participants (such as sending pre-visit information at time of first visit to a participant). Any updates to HEco user profile can also be sent to participants in HEco via multiple modes (such as ‘on demand’, ‘scheduled’). Consider an example where a user changes his insurance due to change in his job. System allows user to send (herein referred to as ‘push”) new/updated information to participants in his HEco.

The Present System allows a user to specify security privileges to restrict access to information and functions related to his HEco. The user can configure preferences for reminders, alerts for his HEco.

Many health and wellness trends in smaller or wider geographical area are relevant to and impact a user. An informed user would like to keep abreast of these health trends and developments. For example, the user and dependents are often impacted by CDC alerts and warnings. An example implementation of the invention, allows the user to receive automatic alerts from CDC based on rules that determine which alerts are relevant for the user and his dependents.

In an example implementation of the invention, system allows user to define his HEco user profile, to manage and analyze health and wellness related information, to perform analytics on health and wellness related information, to perform health and wellness related day today functions, to access health and wellness related information from the participants in his HEco and to maintain and manage an active relationship with participants in his HEco electronically and securely from one place.

The system allows user to register himself and his dependents and define HEco profile for self, and dependents. System allows an insurance holder herein referred to as the “Primary User” and individuals covered under his insurance herein referred to as “Dependent User” to set up their own individual credentials. System allows “Primary User” to be able to centrally manage “Dependent Users” who are covered under his insurance and hence are participants in his HEco.

System allows user to collaborate and engage with participants in his HEco. System supports a messaging mechanism to allow user to communicate real time with participants in his HEco via a variety of protocols including emails, voice, video, text chat.

System allows user to add multiple participants to his HEco. System maintains a directory of supported/integrated participants herein referred to as “EX directory”. System stores basic information about the integrated participants here in referred to as “HEco participant profile”.

System allows a user to configure security privileges, preferences (such as preferences for well check reminders) and rules as they relate to actions and information managed in the system.

System provides a mechanism to integrate with participants in user's HEco and retrieves (here in referred to as “pull in”) relevant information from the participants in multiple modes such as at the time a user logs in to system also referred to as “login” of user and as and when requested by user also referred to as “on demand”.

System allows user to send HEco profile to one or more participants. An example of such a scenario is when a user changes insurance provider, he can choose to push new insurance information to participants in his HEco.

System allows user to perform a variety of day today functions such as scheduling visits, requesting to send pre-visit forms “on demand” prior to an upcoming visit, requesting co-pay statements, requesting health records for school and child care facilities, requesting prescription refills and immunization records.

System allows user to access health and wellness related information (such as “visit summary”) from the participants in his HEco.

In an example implementation of the invention, system allows primary user to search the EX directory which is a list of participants integrated with the system to find participants of his HEco.

In another example implementation of the invention, system allows a guardian user to manage HEco of another insurance holder. The guardian user is herein referred to as ‘Secondary User”. A Secondary user acts as the proxy for the Primary User. In such a scenario, the system allows the Primary User to provide authorization to Secondary User via secured mechanisms compliant with Health Insurance Portability and Accountability Act (HIPPA) rules. A Primary user may allow access to one or more functions or information in his HEco to the Secondary User.

In another example implementation of the invention, system allows users to upload data from a variety of health and wellness related devices and peripherals into his HEco. Data from such devices is maintained as health and wellness related home monitoring data which can be pushed to participants in user's HEco on a need basis.

In an example implementation of the invention, system allows authorized emergency services to query user's HEco to request information in situations of emergency.

In an example implementation of the invention, system provides services to support data analytics. System supports such analysis as analyze a user against his health habits such as discipline with yearly well checkups.

Data analytics services provide a variety of analysis for use by such participants as Primary User, agencies such as CDC.

In an example implementation of the invention, system provides user interfaces for a variety of portable and mobile devices.

### BRIEF DESCRIPTION OF DRAWING FIGURES

FIG. 1 is a block diagram illustrating a process of basic user registration and HEco user profile set up in the system.

FIG. 2 is a block diagram illustrating a process of Security set up by Primary User.

FIG. 3 is a process flow chart illustrating process of registration of participants into HEco of a user.

FIG. 4 is a block diagram illustrating process of requesting prescription fills and refills.

FIG. 5 is a block diagram illustrating process of requesting appointments.

FIG. 6 is a block diagram illustrating process of requesting healthcare bill payment.

FIG. 7 is a block diagram illustrating process of online care exchange with a nurse provider.

FIG. 8

FIG. 9 is a block diagram illustrating process of requesting HEco analysis.

FIG. 10 is a block diagram illustrating actions which are performed when a user logins to his HEco.

FIG. 11 is a block diagram illustrating jobs which are scheduled by the system.

FIG. 12 is a block diagram illustrating process of requesting visit summary.

FIG. 13 is a block diagram illustrating high level architecture/design of the system.

FIG. 14 is a block diagram illustrating high level architecture/functional modules which make up the system.

### DETAILED DESCRIPTION OF THE INVENTION

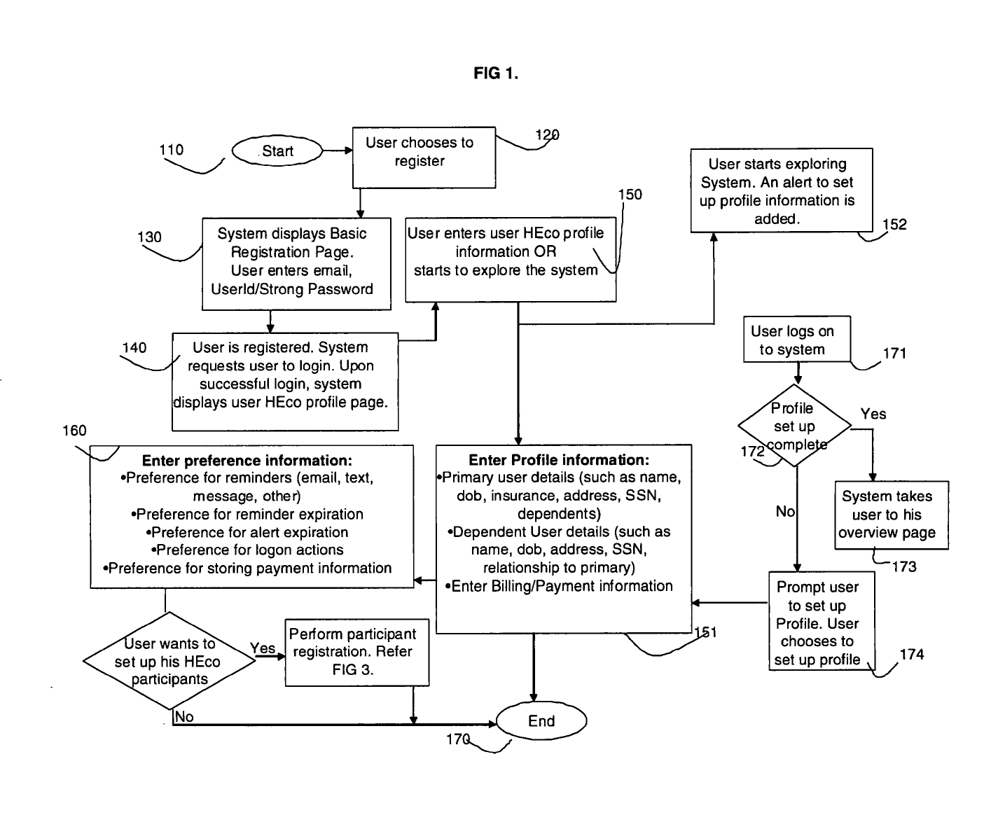

For sake of simplicity flow diagrams discussed below do not describe process of login. For flow diagrams discussed below, it is assumed that user has performed a secured login into system by using a unique username and strong password communication which is obtained by flow as described in FIG. 1.

Security check is a function that is performed before any action requested by user is performed. Failed security check step is skipped from block diagram as block diagrams are illustrating happy path scenarios. In case of failed security checks system displays message to user indicating he/she does not have privileges to perform requested action.

FIG. 1 is a flow chart illustrating the process of basic user registration and HEco user profile set up in system. At step 120 user chooses to register. Step 130 allows him to perform basic registration using his email, chosen username and password. Security module at this point enforces user to choose a unique username and a strong password.

At Step 140, user is registered and can login to system. User performs a secured login into system by using a unique username and a strong password combination which is obtained at step 130.

User is registered; he can perform limited actions. By default, registering user is “Primary User”.

Step 150 allows user to choose to set up a detailed profile or to start to explore the system.

Step 151 allows user to set up a detailed profile for himself. Profile information includes basic demographic information such as name, DOB, insurance information, address, Social Security Number (SSN). User also sets up his payment information to be able to pay healthcare bills via the system.

Step 160, allows user to choose to set up his preferences for his HEco which include:
Preferences for reminders (email, SMS, other)
Preference for reminder expiration
Preference for alert expiration and overrides
Preference for logon actions
Preference for storing payment information

Performing the Steps 151 thru 160 enables user to perform a wide variety of actions via his HEco.

Alternatively, Step 152 allow user to skip detailed profile set up at this point and explore the system. User can come later to perform detailed profile set up.

User “logins” via step 171 and system checks if profile set up for user is complete via step 172. If profile is not set up, system prompts user to set up profile via step 151 thru 160. If user chooses to not set up profile at this time he is taken to his overview page via step 173.

Alternatively if profile set up is found to be complete for user via step 172, e system take user to his overview page via step 173.

In an example implementation, primary user can configure himself as a secondary user who acts as guardian user for another insurance holder. Secondary user is not part of this insurance holder's eco system, he is a Proxy. An example scenario is when a child is acting as Proxy for his senior parent. In such a plausible scenario, when a user designates himself as “secondary user”, system requests Primary User to authorized “Secondary User” as per HIPPA rules. Multiple HIPPA compliant modes are supported for authorization of secondary user.

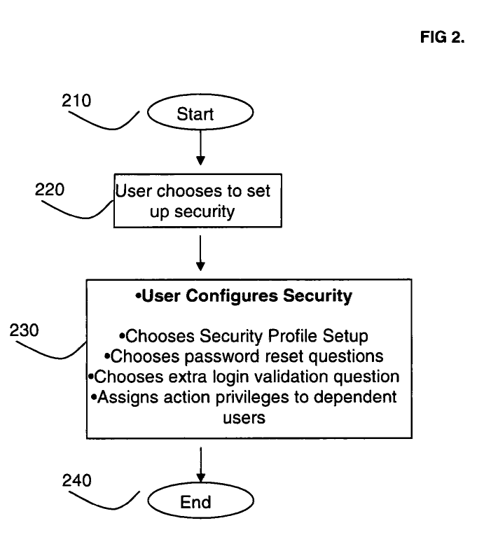

FIG. 2 is a flow chart illustrating process of Security set up by “Primary User”. At Step 220, user chooses to perform security set up for his HEco. At Step 220, system checks security of user. “Primary User” is allowed to perform security set up. If user is not a “Primary User” system displays a message indicating user cannot perform security set up.

In At Step 230 “Primary User” is allowed to set up a wide variety of security for him and his dependent users. He can configure:
Password reset questions
Extra login validation question for himself and his dependent users
Assigns action privileges to dependent users (such as a dependent user has access to view appointments, alerts and reminders in his eco-system).

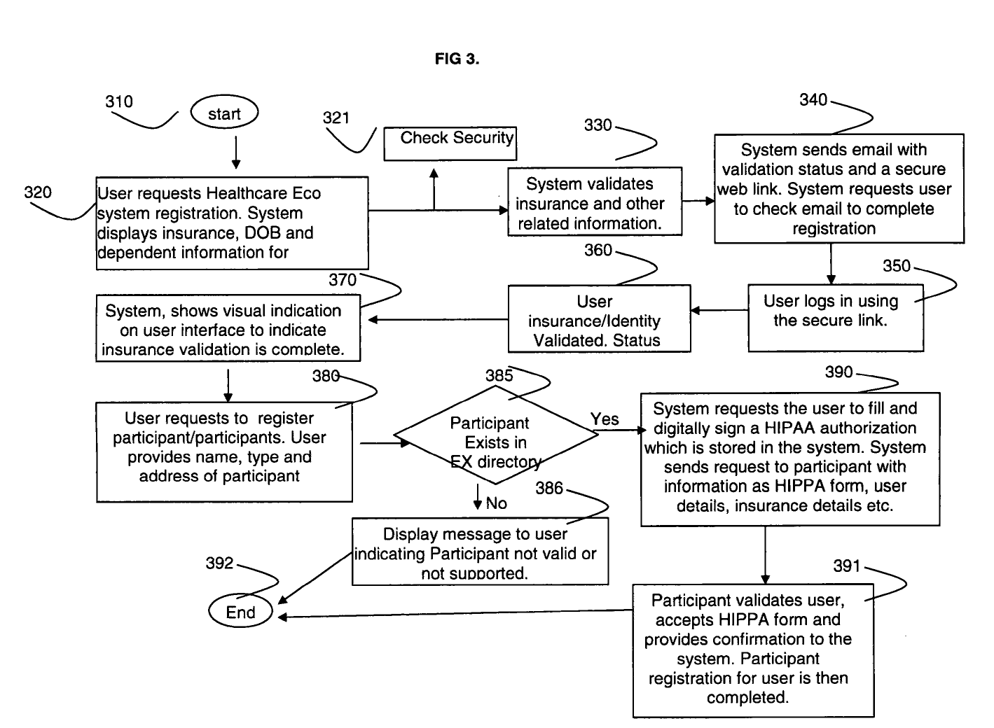

FIG. 3 is a flow chart illustrating process of HEco participant registration in the system. Registration includes validation of insurance and insurance holder and registration of participants and HI PPA authorization for participants.

In At Step 320, user chooses to register his HEco. System displays user's SSN, DOB, insurance and dependent information and validates if it is correct. At Step 321 user's security is checked to ensure he has privileges to perform registration. If user does not have privilege, a message is displayed indicating to user he is not privileged to perform requested action.

At Step 330, the system validates insurance holder by sending a request to insurance participant. If insurance provider validates user, system At Step 340 sends a secure link to user's email. User is requested to check email and complete insurance validation by clicking on secure link. Once user completes Step 350 and confirms registration via secure link, user from that point on is a valid insurance holder as illustrated in 360. His status is updated in system. This status drives a visual indication in user interface via Step 370.

Step 380 user further requests to register participants in his HEco. User can register one or more participants and one or more participant types at this point. User enters such information as the participant name, type and address.

At Step 385, system validates if participant is a valid participant (participant exists and the type is valid). The system then validates if integration with the participant is supported.

At step 390, participant is valid and integration with participant is supported, the system requests user to fill and digitally sign a HIPPA authorization. System sends validation request to participant with information such as HIPPA form, user details, insurance details.

At step 391, the participant validates user, accepts HIPPA form and sends a confirmation back to the system. The system updates the status of the participant as registered.

Alternatively if participant is not valid or not support, step 386 displays a message to user indicating that participant is not valid or not supported.

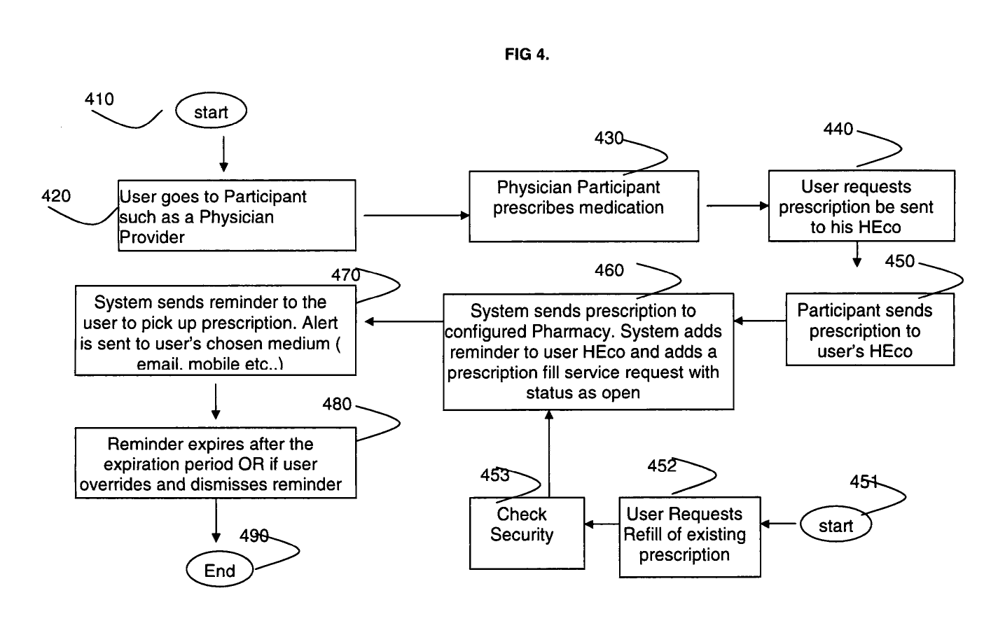

FIG. 4 is a flow chart illustrating process of requesting prescription fills and refills via the system.

A user can either request prescription fills or refills via his HEco. In an example scenario at Step 420, user visits a participant in his HEco such as a physician provider. At step 430, physician provider writes a prescription. At step 440 user requests prescription be sent to his HEco. User can be identified by one or multiple combinations of SSN, DOB, insurance or Master Patient Index (MPI).

Participant sends prescription via the HExchange module into the system via step 450.

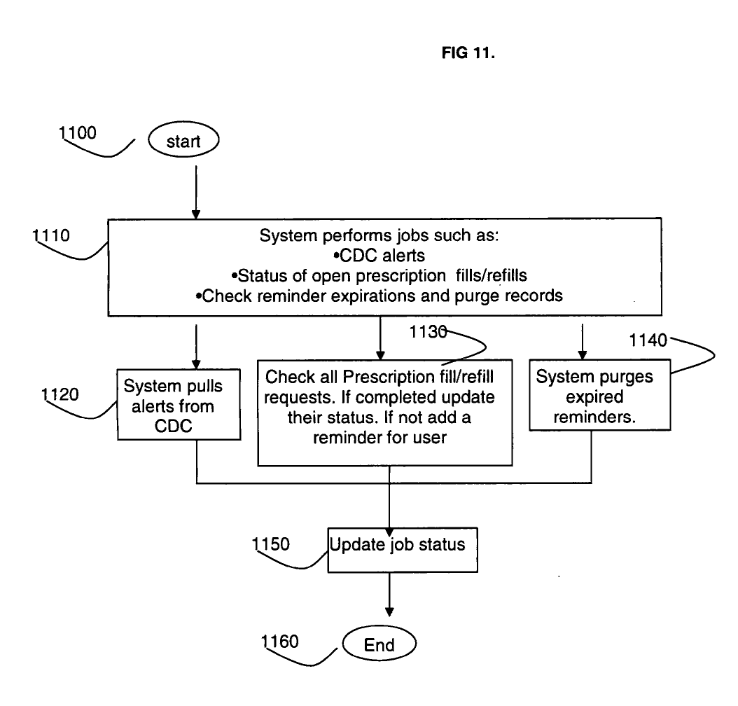

In Step 460, the system sends a prescription fill request via the HExchange module to the pharmacy registered in user's HEco. At this point system adds a reminder for user for prescription pickup, adds a prescription fill service request for user and also marks the status of the service request as open. The batch jobs described in FIG. 11 check the status of open service requests nightly and update the status.

At step 470 system sends reminder to user's chosen medium (SMS, email etc.). Step 480 the reminder might expire or user may choose to dismiss it.

In an example scenario, user runs out of the prescription and needs to order a refill. In Step 452, user chooses prescription refill in the system. The system checks security to ensure user has privileges to perform action at Step 453. If user has privileges the system performs Step 460 and 470 as described above. If user does not have privilege, a message is displayed to user indicating he is not privileged to perform requested action.

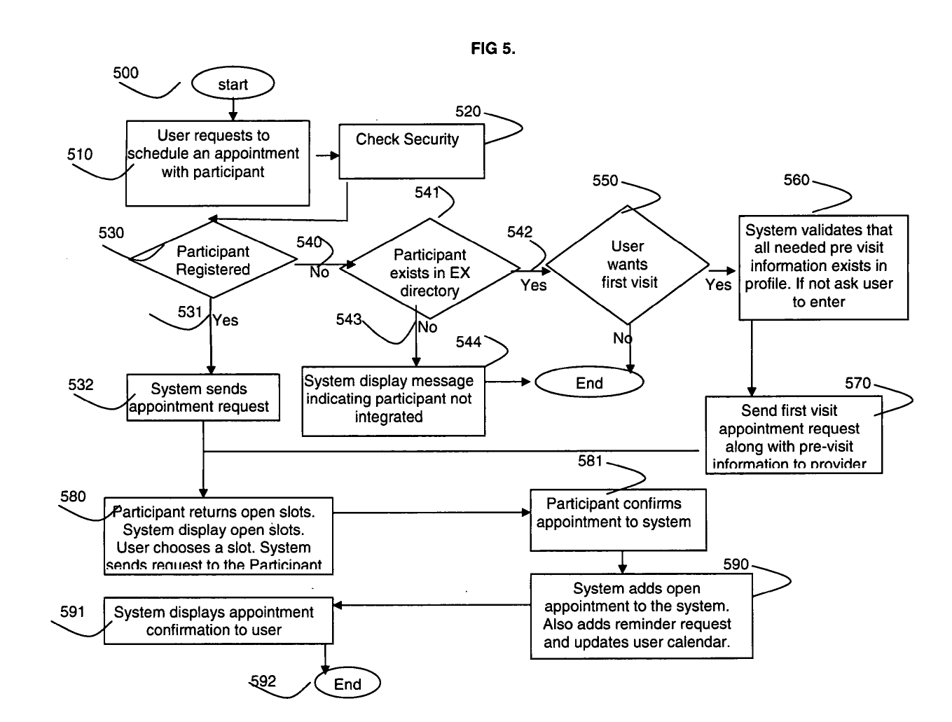

FIG. 5 is a flow chart illustrating process of requesting appointments via the system.

Step 510, user chooses to schedule an appointment with a participant. The system performs security check at step 520 to ensure user is privileged to perform the action. If user does not have privilege, a message is displayed to user indicating he is not privileged to perform the requested action.

The step 530 checks to ensure the participant is registered.

Step 531 checks if the participant is registered. The system sends the appointment request details to the participant via step 532.

Step 580, system receives response from participant with potential date/time slots. User is shown the time slots. Once user chooses a slot, the system sends the chosen slot information to the participant. At step 581, the participant sends confirmation of the appointment to the system. At step 590, the system adds a reminder for the appointment and adds an open appointment request to the system with status as open. The appointment confirmation is displayed to user at step 591

In another scenario, at step 540 the system determines that the participant is not registered. At 541, the system checks to see if the participant integration is supported. At step 542 the system checks if participant is found in EX directory. At Step 550 checks if user wishes to schedule a first visit with the participant. Step 560 checks if pre-visit information is available. If not, system asks user to fill pre visit information. The pre-visit information is stored for future needs.

At step 570 the system sends the first visit request along with the pre visit information. In the next step 580, the participant responds with potential date/time slots. User is shown the time slots. Once user chooses a slot, the system sends the chosen slot information to the participant. At step 581, the participant sends confirmation of the appointment to the system. At step 590, the system adds a reminder for the appointment and adds an open appointment request to the system with status as open. The appointment confirmation is displayed to user at step 591

At step 541, the system determines that integration is not supported and in step 544, user is displayed a message indicating that the participant integration is not supported

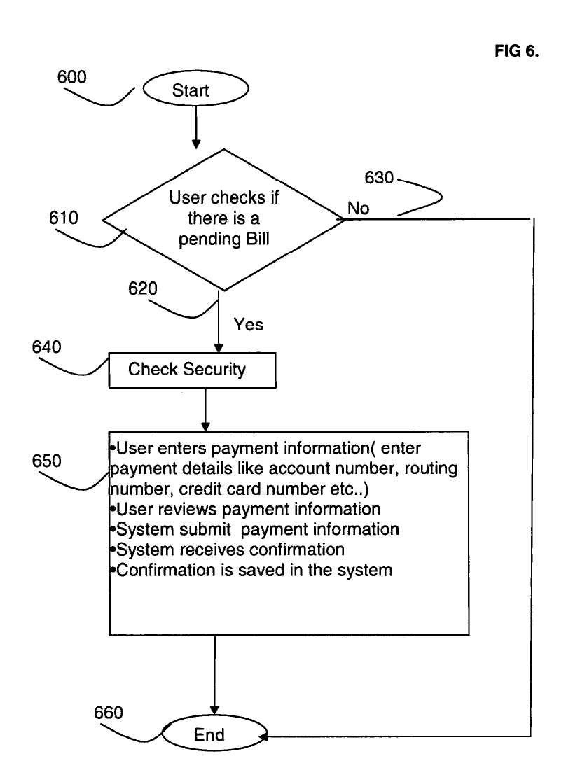

FIG. 6 is a flow chart illustrating the process of requesting healthcare bill payment via the system.

At step 610 user requests to see pending bills. The system performs security check at step 640 to ensure user is privileged to perform the action. If user does not have privilege, a message is displayed to user indicating he is not privileged to perform requested action.

At step 650, user enters payment information (such as account number, routing number etc.) or chooses payment information already stored in the system, reviews the payment and submits payment. The system sends payment request to the participant via the HExchange module. The system receives confirmation which is displayed to user and is also stored in the system.

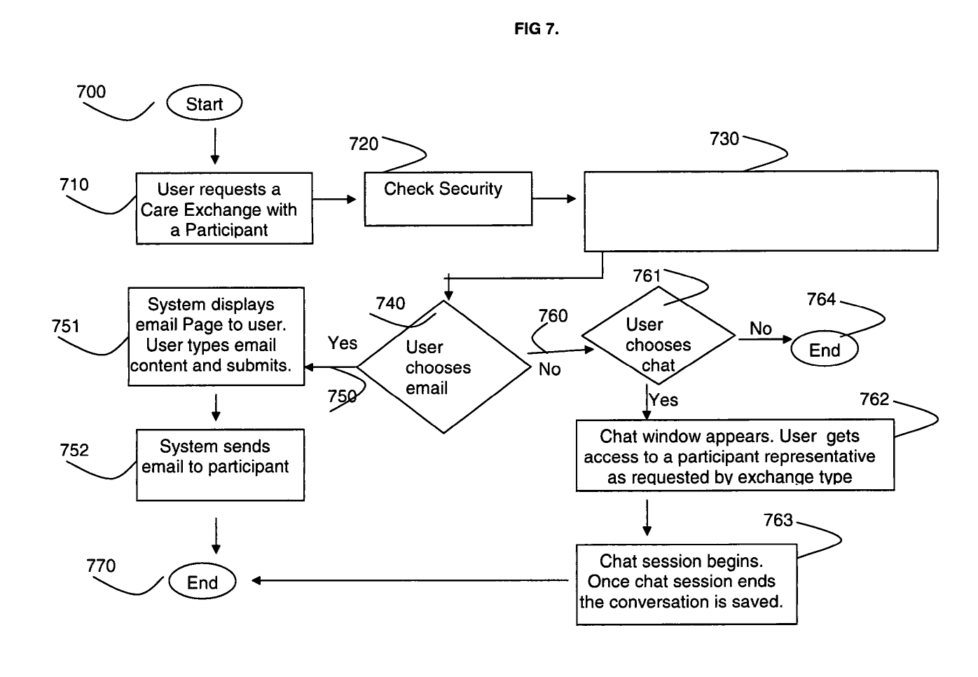

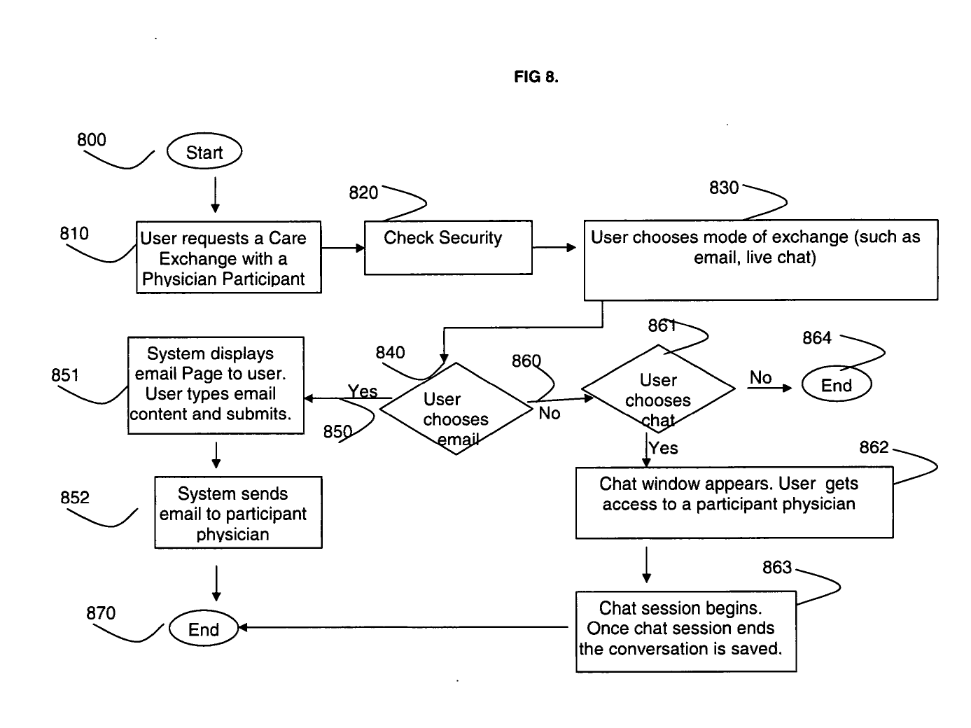

FIG. 7 is a flow chart illustrating the process of online care exchange with a nurse participant

At step 710 user requests a care exchange with a participant nurse. The system performs security check at step 720 to ensure user is privileged to perform the action. If user does not have privilege, a message is displayed to user indicating he is not privileged to perform requested action.

At step 730, if user has privileges system displays a list of options for the user to choose from: mode of exchange (such as email, chat) and exchange type (such as nurse, physician or general). User chooses his mode of exchange and type of exchange. If user chooses email via step 740 system displays email window to user at step 751. User types his message at 752 and system sends it to participant via communication module at step 752.

If user chooses chat via step 761, system open a chat window (connection with participant system is established via communication module. user waits for participant representative to become available at step 762. Once a participant representative joins chat user starts conversation. Conversation is stored in system by default via step 763

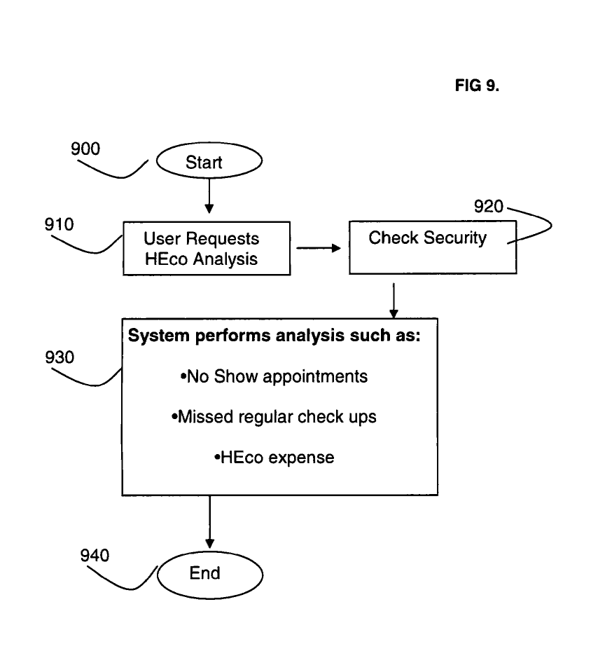

FIG. 9 is a flow chart illustrating the process of requesting HEco analysis.

At step 910 user requests an HEco analysis. The system performs security check at step 920 to ensure user is privileged to perform the action. If user does not have privilege, a message is displayed to user indicating he is not privileged to perform the requested action.

At step 930 via the data analysis module the system performs analysis of user's HEco.

Example of type of analysis performed is:
Has user been regular with his visits (dentist appointments, yearly checks ups, periodic checkups for dependents etc.)
Have there been any no show appointments
What is co-pay expense for the specified period.
What expense is not covered by insurance for the specified period.
HEco related expense to help user plan for the next year Flexible Spending Account (FSA) budget

The data analysis can be done in many ways and combinations. Above is an example of most common analysis. More scenarios are possible and customizable by users and participants.

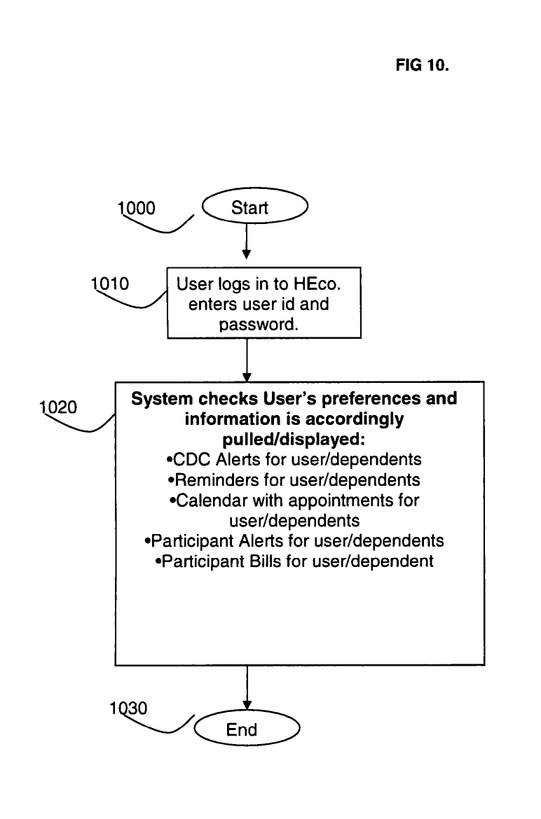

FIG. 10 is a flow chart illustrating actions which are performed when a user logins to HEco. User “logins” to system via “Authentication/Security” module at step 1010. At 1020 via preferences module, system checks for user preferences and determines what information to be displayed to user and what actions to be performed at login. Based on preferences system perform actions such as:
Determine CDC Alerts for user/dependents based on age, sex and other configured attributes
Check system for reminders for user's HEco and display them.
Check pending appointments for user's HEco and display them on HEco Calendar for user.
Check if there are any participant alerts from participants in user's HEco and display them.
Check for pending bill in the HEco and alert the user.

FIG. 11 is a block diagram illustrating batch jobs performed by system. “Jobs” module at step 1110 performs a variety of scheduled jobs. These jobs are run at night to improve efficiency. In an example implementation of module, following jobs are performed—
At step 1120, System “pulls in” CDC alerts at the chosen frequency.
At step 1130, System checks status of open service requests (such as open prescription fill, refill requests). System checks for open prescription requests in user's HEco and requests the status of open requests from the relevant participant and alerts the user if the prescription has not been picked up.
At step 1140, system performs maintenance functions nightly. An example of such maintenance is to check for reminders that have expired and purge them from system.
At step 1150, update the job status.

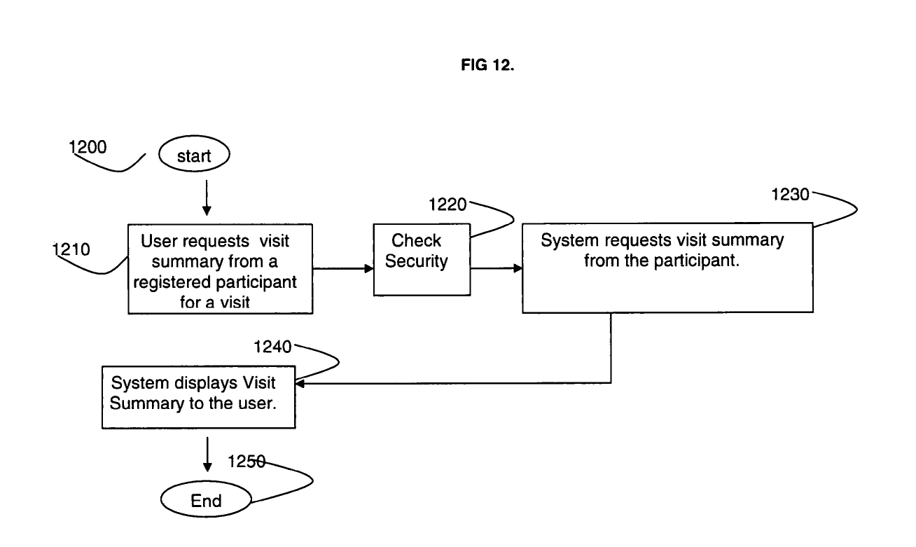

FIG. 12 is a block diagram illustrating process of requesting visit summary via the system.

At step 1210 user requests to view visit summary from a participant. System performs security check at step 1220 to ensure user is privileged to perform action. At 1230 system requests visit summary from participant for a chosen visit via HExchange module. The visit summary is displayed to user at step 1240.

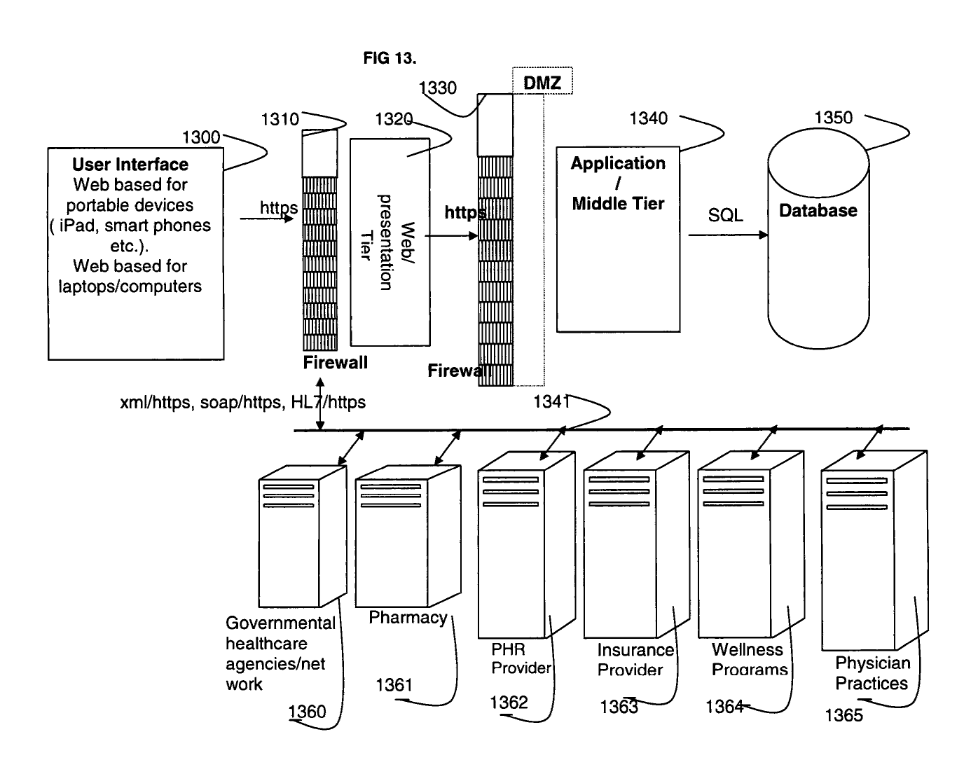

FIG. 13 is a block diagram illustrating high level architecture/design of example implementation of system 1300 represents user accessing the system via a variety of devices—smart phones, PDA's, laptops, computers etc.

1310 represent the secured firewall which opens limited ports to allow user requests to come in and responses to go out. Other traffic is barred.

1320 illustrates the thin presentation layer hosted on a web server. The web server is typically hosted outside the DMZ(demilitarized zone).

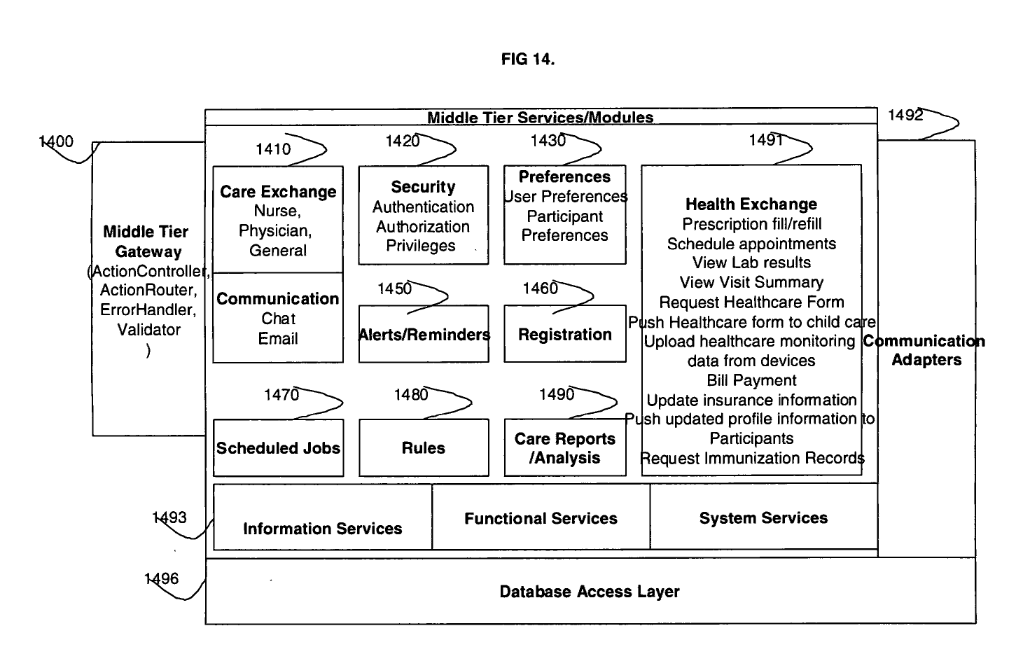

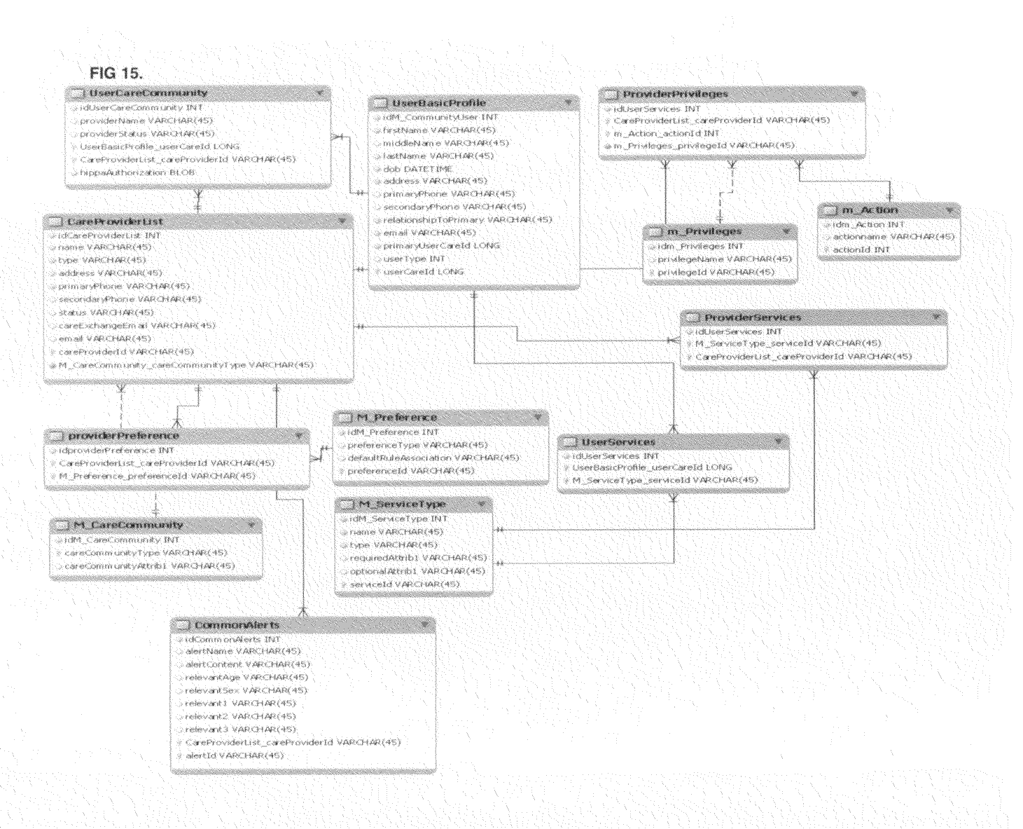

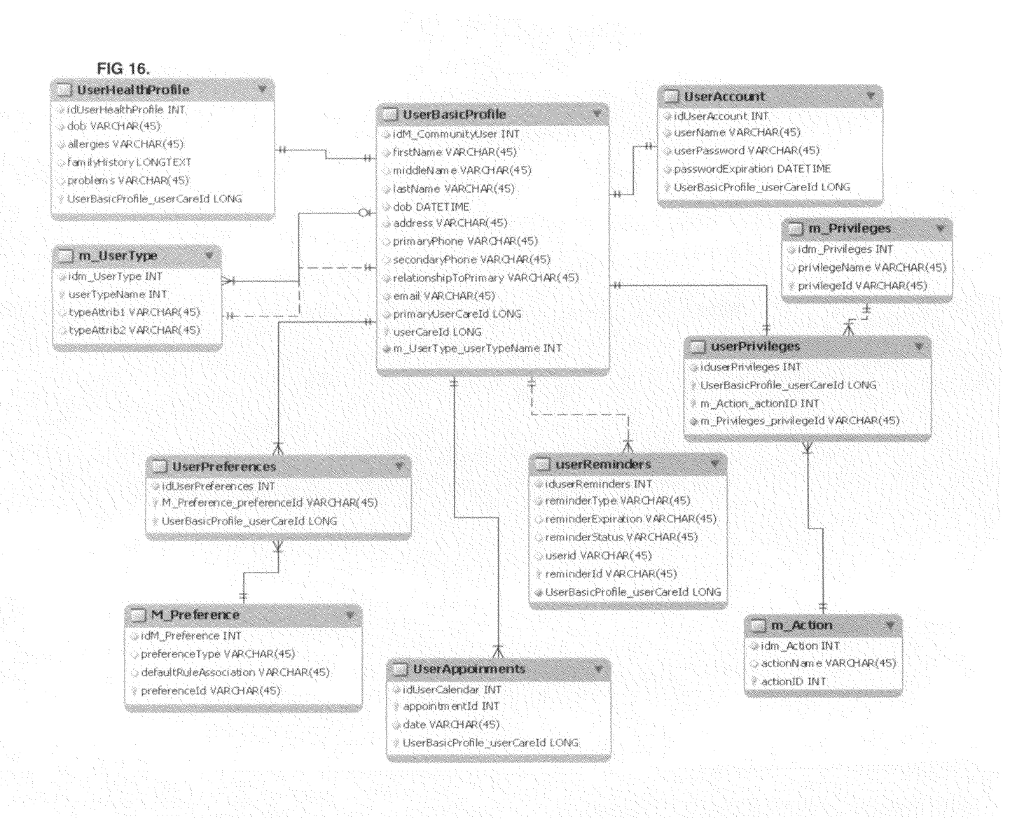

1340 illustrates the application or middle tier as an abstraction of FIG. 14 which discusses the middle tier in detail.

1350 illustrates the database as an abstraction of FIG. 15, 16 which discuss the database in detail.

1341 illustrates the integration with multiple participants such as 1360 as CDC, 1361 as pharmacy, 1362 as PHR provider, 1363 as the insurance provider, 1364 as wellness programs and 1365 as healthcare provider practices. The integration is discussed in detail in FIG. 14 under the “H Exchange Module”

In an example deployment, web servers, application servers and database servers may be clustered to offer scalability to system. Clustering has been omitted from figure to avoid complexity. Clustering is part of internet based architecture deployments.

FIG. 14 is a block diagram illustrating architecture/functional components or design layers/concepts which make up the system.

1400 illustrates middle tier gateway layer which is responsible for handling incoming and outgoing user requests to system. Presentation layer interprets user's requests (ActionController), maps them to actions and routes the request appropriately to a functional module via the ActionRouter component. The presentation layer perform basic validations using a Validator component, for incoming requests and trap the outgoing errors to return meaningful errors to user and log them appropriately using the ErrorHandler. The gateway seamlessly check security for requested actions by invoking security module.

1410 illustrates the care exchange module which is responsible for personal care interactions b/w user and the participants in a user's HEco. The care exchange module implements business logic to audit care conversations based on user preferences which can be retrieved via preferences module. The care exchange module has a loosely coupled communication sub module to support chat and email conversations.

1420 illustrates security module which is responsible for managing authentication, authorization and privileges related functions in the system. The security module stores the account information, authorization and privileges for users. The module checks for user credentials at “login” and privileges at the time of actions or requests performed by a user. The security module audits security actions for tracking purposes. The module enforces a strong password scheme for users.

1430 illustrates preferences module which is responsible for managing preferences for users, participants and the HEco. The preference module stores preference meta-data and preferences for users and participants. It provides access to the preferences to other modules in the system via its services.

1450 illustrates alerts/reminders module which is responsible for managing alerts and reminders. System supports a alerts and reminders mechanism to alert user of appointments, immunization schedules, CDC alerts etc.

System maintains rules that allows system to generate dynamic alerts/reminders for user. An example includes sending relevant CDC alerts based on age group of members in user's HEco. Module stores reminder expiration and alert override rules.

Module provides services to check for reminders for users (such as primary user, dependent user). Alerts/reminders module uses preference module to store alert “pull in” frequency for participants such as CDC and other rules such as purge rules for expired reminders. Module uses HExchange module to “pull in” alerts from other participants.

1460 illustrates registration module which is responsible for managing registrations into system. Module manages basic registration, HEco user profile set up, HEco participant registration and insurance validation as discussed in FIG. 1 and FIG. 3. Module uses HExchange module to perform insurance validation and participant registration. The module is responsible for collecting the HIPPA authorization for participant registration.

Module is responsible for updating user, insurance and participant status in the system at the end of the registration request.

1470 illustrates the jobs module which is responsible for managing batch jobs in the system. The batch jobs as discussed in FIG. 11 are managed by this module.

1480 illustrates rules module which is responsible for managing rules in system. Rules module supports executing different business logic based on user and participant preferences or needs.

1490 illustrates analytics module which is responsible for managing data analysis and reporting. Data analysis and reporting module supports a variety of reports such as report to assess such attributes as habits, behaviors, discipline of user and dependents. Another example is a report to identify HEco related expense to help user plan for the next year Flexible Spending Account (FSA) budget.

1491 illustrates HExchange module which is responsible for managing the integration between system and a variety of other participants which integrate with the system. Module utilizes communication adapters to communicate via a variety of protocols. HExchange module is agnostic to mode of communication and leaves those details to communication adapters. Communication adapters transform incoming information into a neutral format understood by system and outgoing information into a format understood by the participant.

HExchange module supports a variety of mechanisms such as Health Level 7(HL7), “Direct Project” etc.

Incoming requests from participants come via web server and middle tier gateway. Middle tier gateway invokes security module to authenticate and authorize a participant request and subsequently route request to HExchange module which interprets request, performs audits and invokes service (from domain information services, domain action services or system services).

In an example scenario, a standardized service contract is implemented to support the same service across different participants. HExchange module supports customized services for varying participant needs.

1492 illustrates the communication adapters which support a variety of communication protocols for a bi-directional integration. The adapters are self contained and pluggable in order to support the needs of the participant and allow for an easy integration with new participants. An example of a adapter is soap over https for participants who communicate via soap. Other similar adapters can be plugged in. Communication adapters ensure a secured connection with the participant and comply with relevant HIPPA rules.

1493 illustrates the design that provides the basic elements of the service oriented architecture by categorizing the services into three categories:
Information services (include ‘read only’ information retrievals)
Functional services (include services related to actions being performed by user or any other entity in the system)
System Services (include system related services).

The services are self contained, and have a generic interface. Underlying implementation of the services reuse some of architecture and functional modules. Usage of underlying architectural and functional modules be via other services and loosely coupled to maintain generic self contained nature of services.

FIG. 15, FIG. 16 are illustrating an example database structure. Different implementations have different database model to support nuances of implementation.

Database is structured to store HEco user profile for user and HEco participant profile for integrated participants. Database does not store PHR related clinical information and relies on integration with participants such as a PHR provider to access data stored by a PHR. Database maintains information such as basic profile information, security privileges, provider information, insurance information, preferences. Database maintains basic profile information (such as name, address, phone etc.), security privileges, preferences, email, services supported for a participant.

Database stores and maintains Meta data related to information, entities and actions to support functionality of system.

While foregoing written description of invention enables one of skill in the field to make and use what is considered presently to be an example implementation of invention, those of skill in the field understand and appreciate the existence of variations, combinations, and equivalents of the specific embodiment, method, and examples herein. The invention is therefore not to be limited by the example implementations.

1. Software system comprising a database, a plurality of systems representing healthcare providers, wellness partners, health, wellness related devices and peripherals and other interested and authorized entities, internet to connect with healthcare providers, wellness partners, health and wellness related devices, peripherals and other interested and authorized entities, a plurality of user interfaces, services and rules and a plurality of hosting mechanisms.

2. A Software system of claim 1, comprising services and rule which provide user managed centralized system to enable the user to manage health and wellness related information, to collaborate and manage relationship with health and wellness community, to perform analytics on health and wellness related information, to perform health and wellness related day today functions and to access health and wellness related information from participants in his health and wellness community, electronically by integrating with a plurality of health and wellness participants.

3. Software system of claim 2, comprising plurality of services, rules, and steps which enable enables user to specify demographic information, dependent information and health and wellness profile for self and dependent.

4. Software system of claim 3, comprising plurality of services, rules, and steps which enable integration with a plurality of entities including healthcare providers, wellness partners, interested and authorized entities.

5. Software system of claim 4, comprising plurality of services, rules, and steps which enable user to configure security privileges, preferences and rules related to information managed and actions performed by the user.

6. Software system of claim 5, comprising plurality of services, rules, and steps which enables user to specify participants in his health and wellness community which include healthcare providers , wellness partners , interested and authorized entities and related devices and peripherals.

7. Software system of claim 6, comprising plurality of services, rules, and steps which enable system to support a directory of supported/integrated participants.

8. Software system of claim 7, comprising plurality of services, rules, and steps to enable user to perform plurality of functions including scheduling visits, requesting co-pay statements, requesting health record for school and child care facilities, prescription refills, and immunization records from providers.

9. Software system of claim 8, comprising plurality of services, rules, and steps to enable user to update his profile, dependent information, dependent profile and insurance information and send the updated information to participants in his health and wellness community.

10. Software system of claim 8, comprising plurality of services, rules, and steps which enable a secondary user to manage health and wellness information and perform actions on behalf of another insurance holder also referred to as primary user.

11. Software system of claim 8, comprising plurality of services, rules, and steps which enable user to search directory of supported/integrated to find healthcare providers, wellness partners, other interested and authorized entities related to his health, wellness community.

12. Software system of claim 8 comprising plurality of services, rules, and steps to enable user to maintain and manage an active relationship and collaborate with a plurality of providers, partners, devices and entities in his health and wellness community.

13. Software system of claim 8, comprising plurality of services, rules, steps which provide a messaging mechanism to enable user to communicate real time with participant in his health and wellness community via a variety of protocols including email and voice, video, text chat.

14. Software system of claim 8, comprising plurality of services, rules, and steps which enable authorized emergency services to query the system to pull information in situations of emergency.

15. Software system of claim 8, comprising plurality of services, rules, and steps to enable user to push health and wellness related information to school and child care facilities.

16. Software system of claim 8, comprising plurality of services, rules, and steps to enable user to request healthcare and wellness related information from participants in health and wellness community via multiple modes including at “login” and “on demand”.

17. Software system of claim 8, comprising plurality of services, rules, and steps to enable user to push updated profile information to health and wellness participants.

18. Software system of claim 8, comprising plurality of services, rules, and steps enable user to push pre-visit forms on demand prior to an upcoming visit.

19. Software system of claim 8, comprising plurality of services, rules, and steps which enable user to upload health and wellness related monitoring data from a plurality of devices, peripherals.

20. Software system of claim 8, comprising plurality of services, rules, and steps which provide data analytics to be used by users, participants in health ecosystem and other interested and authorized entities.

21. Software system of claim 10, comprising plurality of services, rules, and steps which enable user to provide authorization to “secondary user” using secured mechanisms compliant with HIPPA rules.

22. Software system of claim 14, comprising plurality of services, rules, and steps to enable user to choose to participate in integration with emergency services.

23. Software system of claim 19, comprising plurality of services, rules, and steps which enable user to send health and wellness related monitoring data to health and wellness participants.

24. Software system of claim 2, comprising plurality of services, rules, and steps which enable user to interface with system via a variety of portable and mobile devices.
